(19) United States
(12) Patent Application Publication
(10) Pub. No.: US 2021/0112968 A1
(43) Pub. Date: Apr. 22, 2021

(54) AUTOMATICALLY TRANSFORMING SEATING AND DINING ARRANGEMENT, ITS APPLICATION, AND METHOD OF CONTROLLING SAME

(71) Applicant: Tevos Ltd., Oakville, CA (US)

(72) Inventors: Andriy Ponomar, Oakville (CA); Volodymyr Ponomar, Oakville (CA)

(73) Assignee: Tevos Ltd., Oakville, OT (CA)

(21) Appl. No.: 17/067,741

(22) Filed: Oct. 11, 2020

Related U.S. Application Data
(60) Provisional application No. 62/923,526, filed on Oct. 19, 2019.

(51) Int. Cl. A47B 3/14; A47B 3/02; E04B 5/43; A47C 13/00; A47B 3/00

(52) U.S. Cl. CPC A47B 3/14; A47B 3/02; E04B 5/43; A47B 37/04; A47B 3/002; A47B 2003/025; A47B 2200/0056; A47C 13/00

(57) ABSTRACT

This invention generally represents a folding and transforming furniture, such as a transforming tabletop and seating surface apparatus that stays clean and used indoors, outdoors, within vehicles, aircrafts, water vessels, for commercial and recreational purposes. The invention refers in particular to an automated assembly of folding tabletop surface, seating surfaces, covers, general frame and extension assembly embedded compactly within a substantially horizontal surface, and controlled by internet of things system, controllers and electrical circuits by receiving signals from embedded sensory equipment to activate electrically, pneumatically, hydraulically and gravity powered mechanisms.

### CROSS-REFERENCE TO RELATED APPLICATION

This application claims priority to and the benefit of U.S. Provisional Patent Application No. 62/923,536 filed Oct. 19, 2019.

### FIELD OF INVENTION

The invention generally relates to automatically retractable furniture and structures for indoor and outdoor use in residential, commercial buildings, recreational vehicles, water and air crafts by being powered by an electronic controller to provide automated functionally.

### BACKGROUND OF INVENTION

Tables and chairs of various types, including folding, are well known and have become common in places with limited space where multipurpose use of space is desired or beneficial. These spaces include, but not limited to, dining halls, restaurants, kitchens, living rooms, yards, patios, public areas, parks, recreational vehicles, trucks, water vessels, aircrafts, air and water ports, train and bus stations. These tables and chairs are typically used on demand when floor space needs to accommodate seating and resting of multiple users. The table surface may be used to facilitate activities such as dining, resting, paper or computer work, game-playing or similar.

Folding furniture typically needs to be removed for storage when not used, or manually folded, compacted and moved or stowed away. When not removed or compacted, the furniture takes up valuable space that could be utilized for other purposes. Additionally, the furniture may become soiled or damaged due to precipitations or wind, unwelcomed people use or loitering, pets or pests, or may be stolen when not secured or locked.

Although folded furniture is more compact than generic furniture, nevertheless, it tends to be large and bulky, and substantial storage space is needed, which is disadvantageous especially for businesses, vessels, aircrafts, smaller dwellings. In case of recreational parks and outdoor cafés, furniture tends to stay permanently outdoors, even when folded, and subjected to vandalism, weather, and theft. Additionally, folded furniture is generally not lightweight, and physically demanding to handle and maneuver.

Independently of the use case, all the issues above result in one, or a combination of these problems: dirty furniture that is not suitable for immediate use anymore, substantial and on-going labour efforts, physical injuries due to folding, unfolding and maneuvering, insufficient space for storage of furniture or for other activities, damage and vandalism of the furniture. The issues above indirectly or directly translate into monetary expenditures, or worsened furniture use satisfaction due to loss of productivity and need for extra employee time, fewer business opportunities due to a singular and non-flexible way of using space, need for additional property space and storage, lost time due to moving the furniture and cleaning the soiled furniture, damages to the furniture, and need for more maintenance and service.

Attempts have been made to solve the aforementioned problems by designing folding furniture that packs small. For example, U.S. Pat. Nos. 7,611,193B2, 8,479,667B2 and 4,040,658A proposed to make foldable furniture with attached wheels for reduced storage space and ease of transportation. However, the resulting folded size is not substantially small, the furniture requires storage space and manual transportation, and the wheels add discomfort and reduce stability while the furniture is being used. U.S. Pat. Nos. 4,415,199A and 5,314,231A present furniture that packs very compact; however, they are not designed for ease of transportation by being hard to maneuver, difficult to carry around, and requiring dedicated storage compartment.

It has also been proposed to keep foldable furniture relatively permanently in place and make it retractable or transformable. For example, U.S. Pat. Nos. 3,659,894A, 3,880,458A, 928,726A and 5,031,563A propose stationary yet transforming furniture solutions where the furniture either hides away or serves multiple purposes. However, the disadvantages of proposed systems are that the furniture needs to be handled manually while transforming. Furthermore, the seating and tabletop surfaces become soiled or wet due to people and pets walking over the surfaces while the furniture is in stowed away arrangement, and because of poor weather conditions or dust. U.S. Pat. Nos. 5,007,673A 5,069,142A and US20050252429A1 addressed the manual handling problem by adding mechanisms to help with transforming, however seating and tabletop surfaces would still be soiled due to the aforementioned reasons.

Lastly, U.S. Pat. No. 5,947,416A addresses most of the aforementioned problems by having a lift-assisting mechanism, and having covers that protect the tabletop from being soiled. However, the proposed solution does not have seating arrangements, table takes substantial vertical and horizontal space underneath the surface when being stowed, and the solution is not suitable for outdoor use.

Therefore, there remains a need in private, transportation, recreational and business sectors for substantially compact transforming furniture solution, comprising a table and seating arrangements that incorporates covers with weatherproof capabilities that can be automatically or remotely controlled without any manual input or human power.

### BRIEF SUMMARY OF THE INVENTION

In one aspect, this invention is a an automatically rising, or transforming, tabletop and seat arrangement assembly, that may include isolated, or a combination of a tabletop surface, seating surface, covers and an extension assembly coupled to a general frame member to move independently from each other or by mutual causation. The tabletop and seating surfaces assembly is transformable between fully retracted and fully compacted, i.e. stowed arrangements. The tabletop and seating surface arrangements generally rise from underneath substantially flat waterproof cover system by utilizing an electronic control board with Internet of Things (IoT) capability with manual backup lever and button controls systems, coupled movably with electrical, mechanical, gravitational, pneumatic or hydraulic means of actuation. The waterproof cover system is adjacent to the floor or a similar substantially flat and substantially horizontal surface, hereinafter referred to as floor surface. The covers keep the seating and tabletop surfaces clean and dry for a more enjoyable use by protecting them from soiling and damages caused by external factors and elements. When in fully retracted arrangement, the table and the seats are a greater distance above the cover system, and when stowed away, the table and seats are disposed underneath the cover system.

In another aspect, this invention may be used indoors and outdoors in residential and commercial building and areas; community use places, parks, ports; mounted to or inside vehicles, vessels, airplanes, with a more extensive list of possible application examples detailed in Table 1.

TABLE 1
Examples of Invention Use and Their Locations

| Location | Examples of Use |
|---|---|
| Residential | Kitchen, living room, backyard, front yard, deck, |
| | gazebo, porch, patio, balconies, apartments and condos, |
| | near pools |
| Commercial | Inside restaurants, cafes, bar, club, venue, trade centre, |
| | hall, large lecture rooms, hotels, on patios, near pools, |
| | diners |
| Transportation | Airports, ship docks, yacht clubs, sail clubs, piers, |
| hubs | resting areas |
| Parks and | Gardens, alleys, parks, campsites, boulevards |
| recreations | |
| Vehicles | Recreational vehicles, pick up truck beds, campers, |
| | camper trailers, busses, vans, semi trucks, lorries |
| Vessels | Cruise ships, yachts, sail boats, motorboats, vessel |
| | decks, berths, cruise ship common use areas |
| Aircrafts | Cabin, passenger and crew member areas |

The invention includes all, or a combination of tabletop, seating surfaces, general frame, extension assembly and cover assembly. The tabletop consists of a reasonably lightweight tabletop surface and frame movably connected to the respectable parts of extension assembly. Each seat consists of a seating surface and frame movably connected to respectable parts of extension assembly. Covers generally comprise covering surfaces and frames movably and pivotably connected to the respectable parts of extension assembly and general frame. Extension assembly comprises structural members, linkage mechanisms, actuators, travel limiters, sensory equipment, cables, and force members movably and restrictedly connected to respectable points on seating surfaces, tabletop surface, general frame and cover system to enable retraction and stowing of the invention. The general frame is the structural, rigid, load-bearing component that connects the aforementioned invention components to an adjacent horizontal indoor or outdoor surface in a building, vehicle, aircraft, or alike aforementioned surface. The frame consists of multiple components connected together by nonpermanent means such as bolts and nuts, pins or similar for ease of transportation, manufacturing and assembly reasons that ultimately results in reduced cost of manufacturing, storage and shipping of the invention. The general frame has plurality of holes, standoffs, and other suitable anchoring points around the perimeter to connect to suitable respectable mating points within one of the usage application areas listed in Table 1. The general frame comprises a plurality of pivotable and static connection points for attachment of actuators, pulleys, cables, linkage, bearings cables, and additional hardware and equipment required to enable a controlled motion of extension assembly. The rest of the space within the general frame is reserved for controllers, batteries, power converters, compressors, and any additional hardware required for control of the invention. In fully stowed arrangement, the invention is completely disposed beneath a floor surface that is generally represented by a flat surface such as floor, raised platform, deck, or similar. The height of the invention in stowed position is substantially low, and in preferred arrangement may be lower than 200 mm-250 mm, or 8 inches-10 inches for compactness and ease of stepping over. In retracted arrangement, the height of the invention rises sufficiently high above surface for comfortable dining and seating. The invention transforms between stowed and retracted arrangements by means of choreographed, programmatic sequence of mechanical movements by manipulating the spatial locations of covers, tabletop, and seating surfaces. When retracted, the seating surfaces and tabletop are completely above the floor surface, which is characterized by the covers. The covers may have openings with smaller sub-covers furnished with actuators, springs, weights or similar mechanisms to create space for extension assembly when the invention is retracted. The subcovers retract automatically when the invention is stowed away. The extension assembly may be supplied with linkage of different lengths to alter seating surfaces height and accommodate users of varying height. Seating surfaces linkages are designed for ease of use to create sideways clearance for legs, thereby cancelling the need to raise the legs while taking a seat. In preferred arrangement, the tabletop linkage of extension assembly is designed to avoid crosslinks between the individual members of the linkage to allow for more space for user legs and knees, and to provide access for handicapped people by creating wheelchair access.

In one exemplary system, in a preferred arrangement, the tabletop rises from stowed to retracted position using a five-bar mechanism, acted upon by linear actuators. Excessive degrees of freedom of the linkage are compensated by motion limiting components. The tabletop surface may rise in a moderately straight vertical fashion until the linkage goes beyond overcentre point and comes in contact with motion-limiting components. The covers are opened by being acted upon by an actuator working in one direction through a plurality of tension members such as cables. Closing is achieved using the same actuation acting in the opposite direction. The seating surfaces are raised from stowed position by actuators working in one direction. When stowed, the seating surface rests upside down underneath the tabletop surface for surface cleanliness reasons. While being retracted, the seating surface linkage is over-reached to flip the seating surface subframe to the ready seating arrangement by means of gravitational forces acting upon an offset centre of mass of the seating surface subframe mounted on pivotable joints. Travel limiting members act to secure the seating surface subframe at a suitable position. While being stowed, the actuators act in the opposite direction to flip the seating surface linkage backwards and locate the seating surface subsurfaces in the stowed position. The tabletop surface may be retracted by a variety of means such as roller, switchover, four bar linkage, cable drive, flip-open, cam following, rocker and slider, scissor-lift mechanisms detailed in this application.

### BRIEF DESCRIPTION OF THE DRAWINGS

The invention will now be described, by way of example only, with reference to the accompanying drawings, in which:

FIG. 1 shows simplified application example of the invention in a neutral environment;

FIG. 2 is a set of front perspective simplified views of a transforming furniture invention according to a first embodiment, demonstrating the deployment cycle, and including major invention components such as tabletop surface, seating surface, general frame and extension assembly;

FIG. 3 is a simplified front perspective view of tabletop, general frame and extension assembly of the invention shown in FIG. 2 in stowed and retracted positions;

FIG. 4 is a simplified side orthogonal view of tabletop, general frame and extension assembly and mechanisms of FIG. 3 shown in sequential transforming positions with acting forces;

FIG. 5 is a simplified front perspective view of seating surfaces, general frame and extension assembly of the invention shown in FIG. 2 in partially stowed and retracted positions;

FIG. 6 is a simplified front orthogonal view of seating surfaces, general frame and extension assembly and mechanisms of FIG. 5 shown in sequential transforming positions;

FIG. 7 is a simplified front, partial perspective view of covers, general frame and extension assembly of the invention shown in FIG. 2 in partially stowed and partially retracted positions;

FIG. 8 is a simplified partial perspective view of covers, general frame and extension assembly and mechanisms of FIG. 7 shown in stages of transformation;

FIG. 9 is a simplified orthogonal side view of an alternative method for retraction of tabletop surface of the invention shown in FIG. 2 by utilizing linkage and sliding mechanisms;

FIG. 10 is a simplified isometric view of an alternative method for retraction and flipping of tabletop surface of the invention shown in FIG. 2 by utilizing linkage and turning mechanisms;

FIG. 11 is a simplified orthogonal view of an alternative method for retraction and extension of tabletop surface of the invention shown in FIG. 2 by utilizing expandable linkage mechanisms;

FIG. 12 is a simplified orthogonal view of an alternative method for retraction and flipping of tabletop surface of the invention shown in FIG. 2 by utilizing linkage and sliding mechanisms;

FIG. 13 is a simplified orthogonal view of an alternative method for retraction and extension of tabletop surface of the invention shown in FIG. 2 by utilizing expandable linkage and unrolling mechanisms;

FIG. 14 is a simplified orthogonal view of an alternative method for retraction and extension of tabletop surface of the invention shown in FIG. 2 by utilizing expandable linkage and individually rotatable mechanisms;

FIG. 15 is a simplified orthogonal view of an alternative method for retraction and extension of tabletop surface of the invention shown in FIG. 2 by utilizing expandable linkage and rolling surface mechanisms;

FIG. 16 is a simplified orthogonal view of an alternative method for retraction and extension of tabletop surface of the invention shown in FIG. 2 by utilizing expandable linkage and pulling mechanisms;

FIG. 17 is a simplified front perspective view of an alternative method for retraction and extension of tabletop, general frame and extension assembly of the invention shown in FIG. 2 in stowed and retracted positions by utilizing sets of concurrent Sarrus linkages coupled with four-bar linkages and powered by one or multiple rotatable or linear actuators;

FIG. 18 is a simplified network, control and connection diagram to facilitate automated transformation of the invention shown in FIG. 1 and FIG. 2.

### DETAILED DESCRIPTION OF THE INVENTION

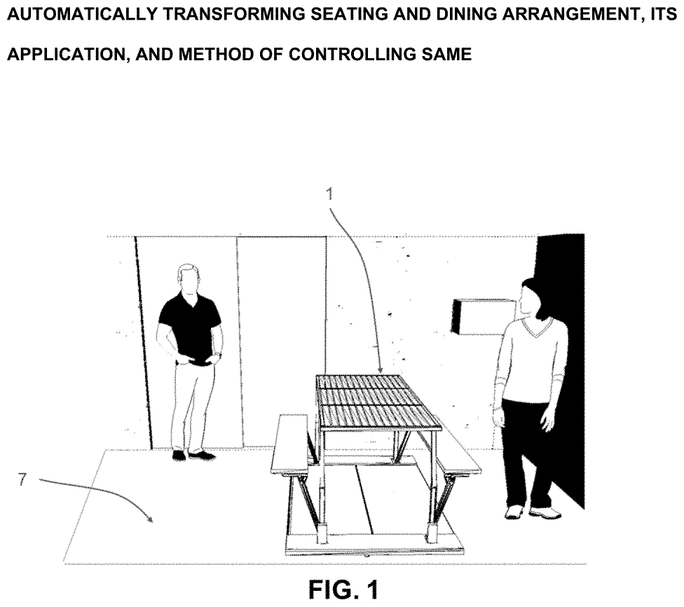

Embodiments of the disclosed table surface with seating arrangement and cover system may be configured and installed in a multitude of ways, with the invention 1 demonstrated in a generic application example FIG. 1. Typically, the invention may find an application indoors and outdoors within vehicles, water vessels, aircrafts, in residential, commercial, transportation hubs, parks and recreation areas, as listed in Table 1. However, benefits of the disclosed invention may be realized in other applications and configurations not listed in Table 1 where floor and vertical spaces are valuable.

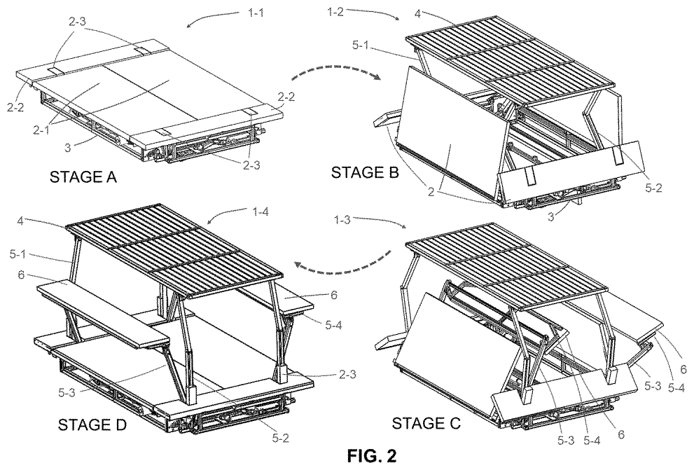

In its most complete arrangement as shown in FIG. 2, the invention 1 comprises cover surfaces 2-1, 2-2, 2-3, table surface 4, seating surfaces 6, general frame 3, and extension assembly 5-1, 5-2, 5-3, 5-4. However, ultimately, a particular application's requirements decide what features are included in the final arrangement of the invention. For example, if the invention is used in the cabin of an aircraft, seating surfaces may not be required; and if the invention is used in an alley or a boulevard, seating surfaces may be included but the table surface may be omitted; if the invention is used in a backyard of residential building, the full set of the invention may be most preferred. Embodiments hereon are discussed for the most complete arrangement.

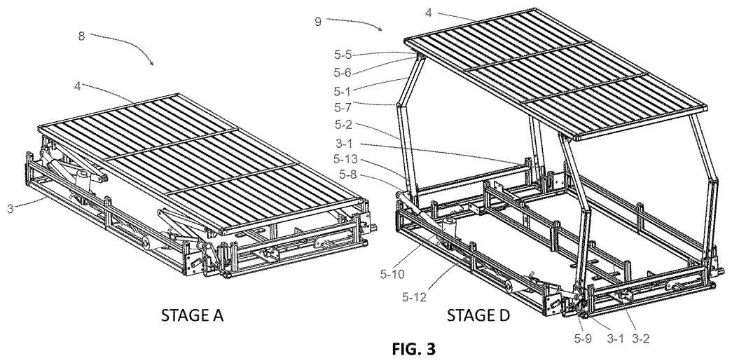

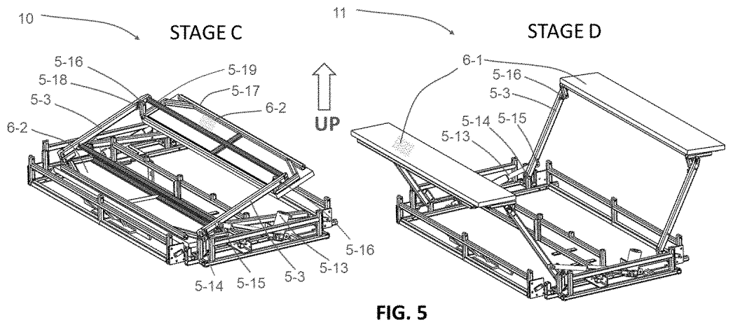

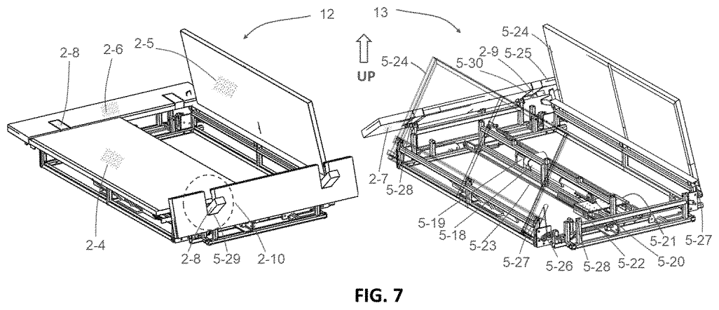

When the invention is installed, moving components of the invention, namely cover surfaces 2-1, 2-2, 2-3, seating surfaces 6, table surface 4 and extension assembly 5-1, 5-2, 5-3, 5-4 are typically configured to be positionable between at least two positions shown in FIG. 2: stowed away 1-1 and fully extended 1-4. In stowed away arrangement, table surface 4, seat surfaces 6, and extension assembly 5 are positioned underneath the cover surfaces 2. Table surface 4 reaches stowed away arrangement 8 in FIG. 3 when the table surface 4 is partially or fully beneath floor 7, FIG. 1 and covered by the cover surfaces 2 of the invention 1. Seating surfaces 6 reach stowed away arrangement when the seating surfaces are turned upside down such that the undersides of eating surfaces 6-2 in FIG. 5 face up, the seating surfaces are fully or partially underneath floor 7, and underneath the aforementioned stowed table surface 4. Cover assembly 2 can be described as stowed away as portrayed in 1-1 FIG. 2 where the cover surfaces 2-1, 2-2, 2-3 are substantially horizontal and substantially in-line with floor 7, FIG. 1, surfaces 2-4, 2-6 facing up, and no parts or protrusions are located above the floor level. Extension assembly 5 is described to be in stowed away position when components 5-1, 5-2, 5-3, 5-4 are positioned underneath the floor 7, FIG. 1. In fully extended arrangement, tabletop surface 4, seat surfaces 6, and associated extension assembly 5 components are positioned above the cover surfaces 2. Fully retracted arrangement for the tabletop can be described when the tabletop surface 4 and associated tabletop expansion assembly 5-1, 5-2 are substantially above the floor and covers. Similarly, seating surfaces 6 are fully retracted when the seating surfaces and associated expansion assembly components 5-3, 5-4 in FIG. 2 are substantially above the floor 7, FIG. 1 and the correct seating surface side 6-1 in FIG. 5 is facing up. Cover surfaces assembly 2 is fully retracted when cover surfaces 2-1, 2-2, 2-3 in FIG. 2 are not parallel to floor 7 in FIG. 1, surfaces 2-5, 2-7, 2-9 are not parallel to the floor and each other, as shown in 1-2 in FIG. 2. The cover surfaces assembly has an in-service position where the tabletop and seating surfaces are fully retracted as shown in 1-4, FIG. 2. During the in-service position, most of the cover surfaces are substantially coplanar with floor surface 7, FIG. 1 except for four cover surfaces 2-3 in FIG. 2 of clearance openings 2-10 in FIG. 7 to clear extension assembly 5 when tabletop surface 4 and seating surfaces 6 are fully extended, thereby allowing free movements and adjustment of other components of the invention. For both stowed away and fully retracted arrangements of the invention, the general frame 3 in FIG. 2 is always situated underneath floor 7 while being rigidly attached to any suitable anchoring elements within the floor or other structures.

Although one configuration of the invention in its operating cycle is portrayed in FIG. 2, other arrangements of the invention not described herein are applicable and may be used. FIG. 2 shows an example of operating cycle of the invention. The example starts with 1-1, where the invention is in fully stowed away position described above. The second stage of the invention retraction is shown in 1-2 of FIG. 2, where actuators within the expansion assembly 5 act upon adjacent expansion assembly subcomponents to simultaneously retract cover surfaces 2-1, 2-2, 2-3 to their fully retracted positions. Another set of actuators act upon 5-2 members to raise tabletop surface 4 and retraction assembly members 5-1 above floor level 7 in FIG. 1, and the position of tabletop surface 4 in 1-2 is portrayed in semi-retracted position. The third stage of the invention retraction is portrayed in 1-3. During the third stage of retraction, the tabletop surface 4 assumes its fully retracted position, along with the associated tabletop retraction assembly components 5-1, 5-2. During the third stage 1-3 of invention retraction, the seating surfaces 6 are sequentially retracted while being acted upon by actuators through retraction assembly subcomponents 5-3, 5-4. The seating surfaces are brought to their final in-service position before retraction stage 4 begins. In stage 4 of the invention retraction as shown in 1-4 in FIG. 2, the cover assembly 2 closes to its in-service position as shown in 1-4 by being acted upon by actuators through the respectable components within the expansion assembly 5. Embodiments to follow provide additional information about the principle of work of the invention.

Embodiments illustrated in FIG. 3 provide isolated views of tabletop-related components of the invention, namely tabletop surface 4, extension assembly 5 and general frame 3. Tabletop surface is demonstrated in both stowed away arrangement 8, and fully retracted arrangement 9. In the given configuration, transforming from the stowed arrangement to fully retracted arrangement is completed using two actuators 5-10, which are pivotably connected to general frame 3 through joints 5-12, acted upon joint lever plate 5-8 that is rigidly connected to extension assembly subcomponent 5-2, that represents the bottom leg for the tabletop surface. Joint lever plate 5-8 and bottom tabletop leg 5-2 are pivotably connected together to general frame 3 at joint 5-9 situated at the lower side of the tabletop leg 5-2. Lower tabletop leg 5-2 is pivotably connected on the other side to one of the ends of the tabletop leg component 5-1 through in-between legs pivotable joint 5-7. Tabletop leg component 5-1 is pivotably connected at the upper side to the tabletop surface 4 through pivotable joint 5-6. To reduce the number of degrees of freedom for the tabletop surface 4 and extension assembly 5, stopping devices are required. Examples of stopping devices are represented by components 5-5 at tabletop surface and 3-1 at general frame. Stopping device 3-1 prevents overtravel of actuators 5-10 and stopping device 5-5 prevents movement of the tabletop surface 4 when the tabletop is in fully retracted arrangement.

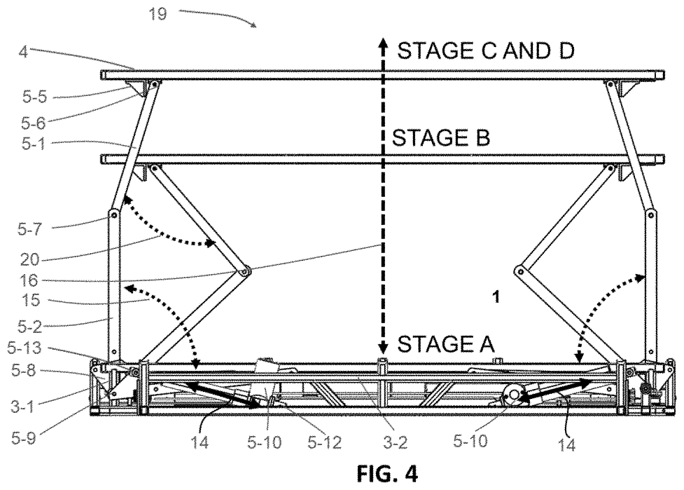

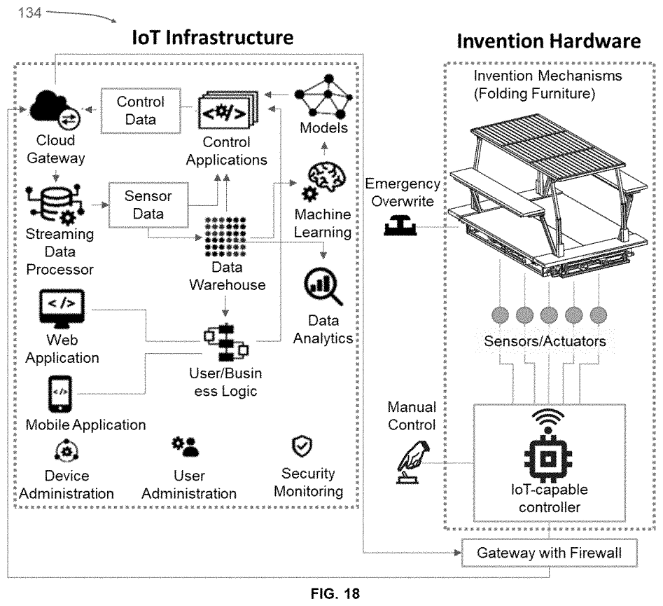

Embodiments illustrated in FIG. 4 demonstrate a suggested mode of operation of the invention to transform the tabletop surface from stowed away arrangement defined by Stage A in 19 to fully retracted arrangement defined by Stage C in 19 while showing an intermediate Stage B in between when pictured from an orthogonal side view. In the exemplary description hereto after, the tabletop surface 4 begins its transformation when actuators 5-10, which are pivotably connected to general frame 3 and lower leg joint plate 5-8 through pivotable joints 5-12 and 5-13, respectively, receive a signal from IoT-capable controller in FIG. 18 to extend, or move such that the tabletop lower legs 5-2 and joining plate 5-8 move radially upwards by following trajectory 15 defined by trajectory centre pivotable joint 5-9 until tabletop lower leg 5-2 comes in contact with stopping device 3-1. Trajectorial movement of lower tabletop leg 5-2 acts upon upper tabletop leg 5-1 through pivotable joint 5-7, which rotates the upper tabletop leg to fully extended position by following trajectory 20 controlled by pivotable joint 5-6 that represents centre of trajectory arc. Upper tabletop leg 5-1 follows trajectory 20 until the tabletop leg comes in contact with stopping device 5-5, which concludes the extension process. Retraction of the invention from fully extended arrangement Stage D in 19 to stowed away arrangement Stage A is completed in reverse order by passing through intermediate Stage B. The tabletop is in stowed away position when the actuators hit the reverse limit of their travel, and when tabletop surface 4 comes in contact with reverse motion stopping protrusions 3-2, FIG. 3 on general assembly 3.

Embodiments illustrated in FIG. 5 provide isolated, perspective views of components related to seating surfaces of the invention, namely seating surfaces 6, extension assembly 5 and general frame 3. Seating surface is demonstrated being in partially stowed away Stage C arrangement 10, and fully retracted Stage D arrangement 11. In the given configuration, transforming from the stowed away arrangement 10 to fully retracted arrangement 11 is accomplished using two actuators 5-13 acting on extension assembly components 5-3 through joints 5-15. Extension subassembly 5-3 is pivotably connected to general frame 3 through joints 5-14. In stowed arrangements the seating surface is turned upside down, where the bottom surface 6-2 points upwards, and in fully retracted arrangement the seating surface is turned such that the actual seating surface 6-1 faces up. Seating surface 6 is generally rigidly attached to seating surface force member 5-17, such as exemplarily demonstrated in FIG. 5. Force member 5-17 is pivotably connected to seating surface extension members 5-3 through pivotable joints 5-16. Force member 5-17 and seating surface 6 rotate between their fully extended and stowed away arrangements around joint 5-16, and rotation outside of predefined limits is restricted by stoppers 5-18 and interference with cross-member 5-19.

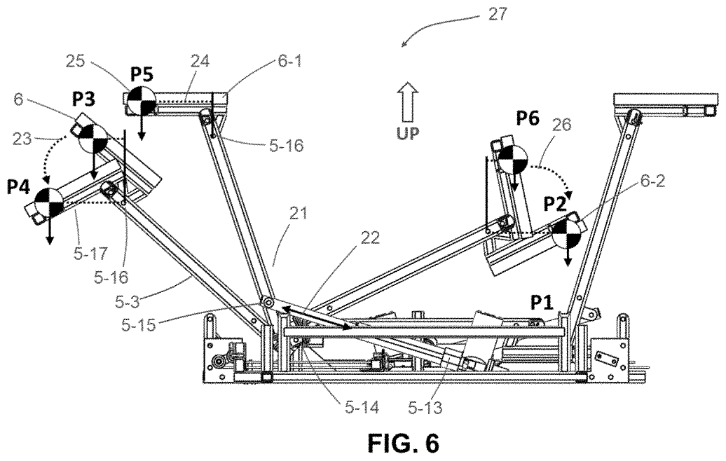

Embodiments illustrated in FIG. 6 demonstrate an example of mode of operation of the invention pertaining to the seating surfaces. Stages P1, P2, P3, P4, P5 and P6 in 27 demonstrate distinctive positions of seating surfaces retraction. The seating surfaces start with stage P1, where the seating surface is in stowed arrangement with 6-2 facing up. Extension assembly component 5-3 moves radially until seating surface 6 reaches position P2. In the given embodiment such result is achieved by actuator 5-13 extending along path 22 to act upon member 5-3 through joint 5-15. At stage P2, the centre of gravity 25 of seating surface 6 and load-bearing extension assembly member 5-17 is substantially far away to the right from joint 5-16 along lever arm 24. Actuator 5-13 must continue acting along path 22 to rotate member 5-3 radially along path 21 until seating surface 6 reaches stage P3. At stage P3, the centre of gravity 25 is located slightly to the left from pivoting joint 5-16 along lever arm 24. Immediately after reaching stage P3 in 27, seating surface 6 rotates to position P4 with respect to pivotable joint 5-16 along trajectory 23 by means of gravity. At stage P4, seating surface 6 assumes its operating location with 6-1 facing up. Seating surface 6 remains in operating position because of interference between seating surface member 5-17 and cross-member 5-19. Actuator 5-13 then moves in opposite direction along 22 to rotationally bring 5-3 and seating surface 6 along trajectory 21 to position P5. Position P5 represents the fully retracted arrangement of seating surface 6. Seating surface is stowed away by retracting actuator 5-13 along path 22 to bring item 5-3 along trajectory 21 to position P6. At P6, the centre of gravity 25 of seating surface 6 and subframe 5-17 is located slightly to the right from pivotable joint 5-16 along lever arm 24. Gravity rotates seating surface 6 and frame 5-17 back to position P2 along trajectory 26, at which the seating surface is upside down, where 6-2 faces up. To conclude stowing, actuator 5-13 continues retracting along path 22 to the end until seating surface 6 reaches position P1, which represents fully stowed arrangement.

Embodiments illustrated in FIG. 7 provide isolated views of components related to cover assembly of the invention, namely cover assembly 2, extension assembly 5 and general frame 3. Covers assembly is demonstrated in partially stowed away arrangement 12, and partially retracted arrangement 13 with components not shown or altered for clarity. In fully stowed away arrangement, top surfaces 2-4, 2-6 and 2-8 face up and are mostly coplanar, while bottom surfaces 2-5, 2-7, 2-9 are equally coplanar and hidden underneath 7 in FIG. 1. In fully retracted arrangement, or at a transitioning stage, all bottom surfaces 2-5, 2-7, 2-9 become visible. In service arrangement, meaning when seating surfaces 6 and tabletop surface 4 are fully retracted, surfaces 2-5 and 2-7 are coplanar and not visible, and surface 2-8 is angled with respect to 2-6 and 2-4 as shown in 2-10. Transforming from the stowed arrangement to fully retracted arrangement is completed using a single actuator 5-18 connected to the general frame 3 at joint 5-19 and to sliding plate 5-21 at joint 5-20. The sliding plate 5-21 has a plurality of cable clamping connections 5-22 to pull cables such as 5-23 front and back acting on retracting assembly components 5-24 and 5-25. Cables 5-23 are guided through cable pulleys 5-26 that are mounted on general frame 3. Cover system retracting assembly components 5-24 and 5-25 are pivotably connected to general frame 3 through joints 5-27 and 5-28. Tabletop leg clearance covers 2-3 of FIG. 2 are pivotably connected to cover components 2-2 of FIG. 2 at joints 5-29. Clearance covers 2-3 are equipped with springs 5-30 to automatically close themselves during the stowing away process.

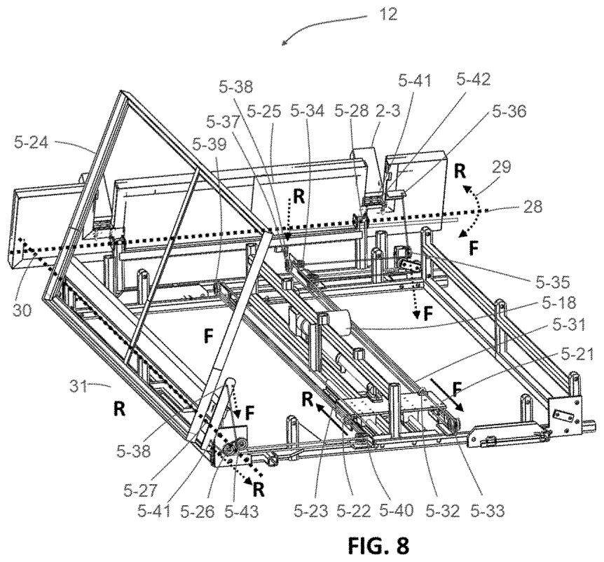

Embodiments illustrated in FIG. 8 demonstrate an example of mode of operation of the invention pertaining to cover assembly 2. Partial view of the cover system 12 is shown with several components not displayed, and similar principle of work is applicable to the rest of the covers. Covers assembly is powered by a single actuator 5-18 that moves sliding plate 5-21 in forward (F) and in reverse (R) directions as defined in 12. The entire cover assembly 2 of FIG. 2 is retracted when actuator 5-18 moves in reverse direction R. The covers are stowed away when the same actuator 5-18 acts in forward direction F. For example, in the isolated view 12, sliding plate 5-21 pulls cables 5-23 and 5-31 by transferring force through cable clamp connections 5-22 and 5-32 located around the perimeter of plate 5-21. When actuator 5-18 moves in reverse direction R, cable 5-31 travels in direction R around pulleys 5-33 and 5-37 to apply force at joint 5-38, which rotates cover subframe 5-25 around axis 28 in R trajectory defined by 29, thus retracting short cover surfaces 2-2 of FIG. 2. The cover 2-2 is stowed when actuator 5-18 acts on sliding plate 5-21 to move it in forward F direction, which moves cable 5-31 around pulleys 5-33, 5-34 and 5-35 to transfer force at joint 5-36. This force rotates cover subframe 5-25 around axis 28 through joint 5-28 in direction F around trajectory 29. Similarly, long covers 2-1 are retracted when actuator 5-18 acts on sliding plate 5-21 to move it in reverse R direction to transfer force through cable clamp 5-22 to cable 5-23. The cable travels around pulleys 5-39, 5-40, 5-26 and applies force to cover surface related frame member 5-24 at joint 5-41. This force rotates cover surface 2-2 around axis 30 in direction R as defined by trajectory 31. Similarly, when the actuator 5-18 acts in the opposite direction to move sliding plate 5-21 in direction F, the cable 5-23 travels around pulleys 5-40 and 5-43 and applies force to member 5-24 at joint 5-38. The force rotates member 5-24 around pivotable joint 5-27 with respect to axis 30 in forward F direction along trajectory 31. In service position, cover members 2-3 are perpendicular to members 2-2 and 2-1 of FIG. 2. Members 2-3 of FIG. 2 are pivotable with respect to 2-2 and are movably joined at joint 5-41. Member 2-2 is retracted by being in contact with tabletop leg members 5-2, which acts on undersurface 2-9 to retract the cover surface member 2-2. Covers member 2-2 is automatically stowed away after service using the tension or torsion spring 5-42.

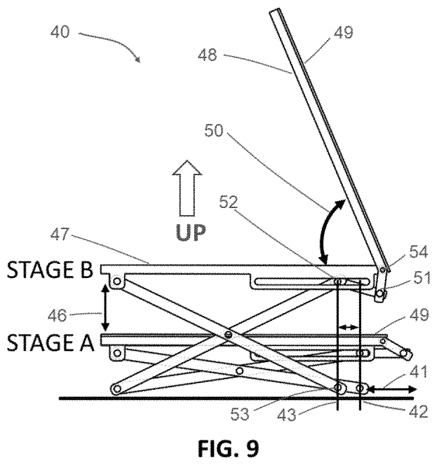

In another aspect of the invention, FIG. 9 shows an alternative mechanism for the invention to retract and stow away the tabletop surface. Fully stowed and partially retracted arrangements are demonstrated in 40, where the tabletop cover surface 49 is stowed away at lower position Stage A and partially retracted at upper position Stage B. When the invention is stowed away, tabletop surface 49 faces up and is subjected to being soiled from external elements. The tabletop surface is transformed from being stowed away to fully retracted position using an actuator that applies force at point 53 along path 41. The stroke of the actuator is sufficiently long to move tabletop leg 53 and sliding peg 52 from point 42 to beyond point 43 along path 41. Motion of actuator along 41 moves the invention frame from Stage A to Stage B along path 46 by means of linkage arranged into scissor mechanism. Additional aspect of the mechanism is automatic unfolding of the tabletop to increase the dining area by factor of two or more, and to reveal clean, protected from the environment and elements surfaces 47 and 48. In fully retracted arrangement, clean surfaces 47 and 48 are coplanar and face upwards, while the soiled surface 49 faces downwards. Such transition is achieved by utilizing linkage mechanism 51 that is acted upon by the sliding peg 52 to rotate surface 49 around the pivotable joint 54 along trajectory 50.

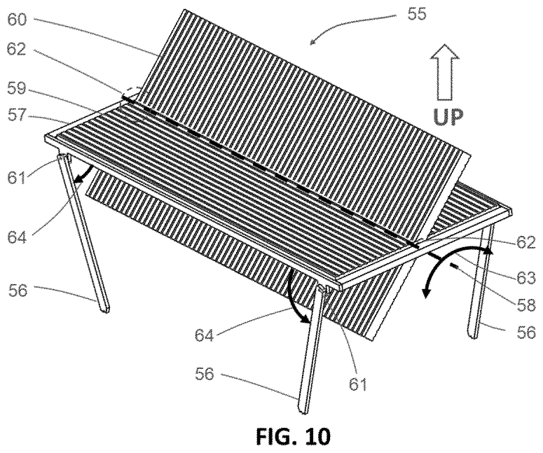

In yet another aspect of the invention, FIG. 10 demonstrates a mechanism for the invention to retract the tabletop surface, as shown in 55. Tabletop frame legs 56 are actuated such that the legs 56 rotate around pivotable joints 61 to follow motion trajectory 64. Pivotable joints 61 connect tabletop legs 56 to tabletop surface frame 57. In fully stowed away arrangement, tabletop surface 59 is soiled and faces up, while the clean, dining surface 60 is hidden and faces down. The invention is situated below floor 7 of FIG. 1 in stowed away arrangement with legs 56 making a sharp angle with respect to tabletop surface frame 57. In fully retracted mode, legs 56 are nearly perpendicular to tabletop surface frame 57, and tabletop dining surface 60 faces up, while the dirty side of the tabletop 59 faces down. The tabletop surface rotates on pivotable joints 62 embedded within tabletop surface frame 57 with respect to axis 58 to follow the trajectory defined by 63. In is most preferred mode of operation, the rotation around axis 58 is automated, and may be actuated by a separate actuator at joints 62 or may be positionally dependent on the location of tabletop legs 56 along trajectory 64, and mechanically linked to tabletop legs 56.

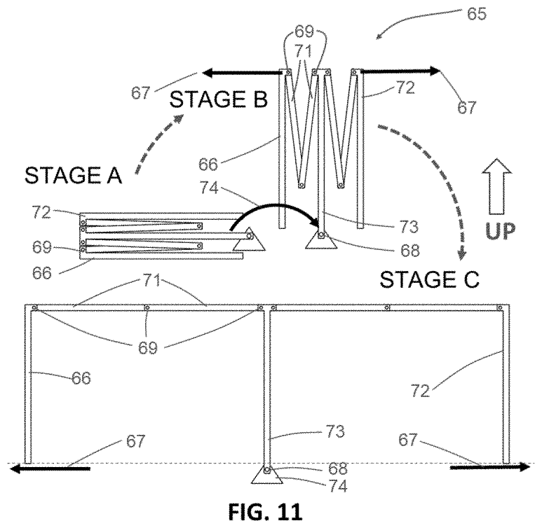

In yet another aspect of the invention, FIG. 11 demonstrates another mechanism for the invention to retract tabletop surface using foldable and pivotable linkage as shown in 65. The invention is in fully stowed arrangement at Stage A with the utilitarian, soiled surface and tabletop leg member 72 being mostly horizontal and facing up, and tabletop legs 66 and 73 being mostly horizontal and located under the floor level 7 in FIG. 1. At Stage B in 65, the mechanism for the invention is in semi retracted arrangement, with the tabletop leg members 66, 72, and 73 oriented vertically. At Stage C, the mechanism for the invention is in fully retracted arrangement, with the tabletop leg members 66, 72 and 73 located away from each other, and clean, dining surfaces 71 being coplanar and facing up. The proposed mechanism consists of a set of linkage members and two or more independent rotary or linear actuators. The mechanism has three tabletop leg members 66, 72, and 73 and four tabletop surface linkages 71 that are connected through pivotable joints 69. Central tabletop leg linkage member 73 is connected to a solid anchorage point 74 through a pivotable joint 68. Retraction of the invention begins at Stage A where the first of the aforementioned actuators acts on tabletop leg 73 to rotate it about pivotable joint 68 along trajectory 74 to bring tabletop legs 66, 72, 73 from mostly horizontal arrangement at Stage A to vertical orientation of Stage B. Second stage of retraction starts at Stage B with the second of the aforementioned actuators acting on tabletop legs members 66 and 72 to pull them away from central tabletop leg 73 along the trajectory defined by 67. At Stage C of 65 the mechanism of the invention is fully retracted, where the tabletop leg members 66 and 72 are fully apart, and tabletop clean surfaces 71 are coplanar and face up.

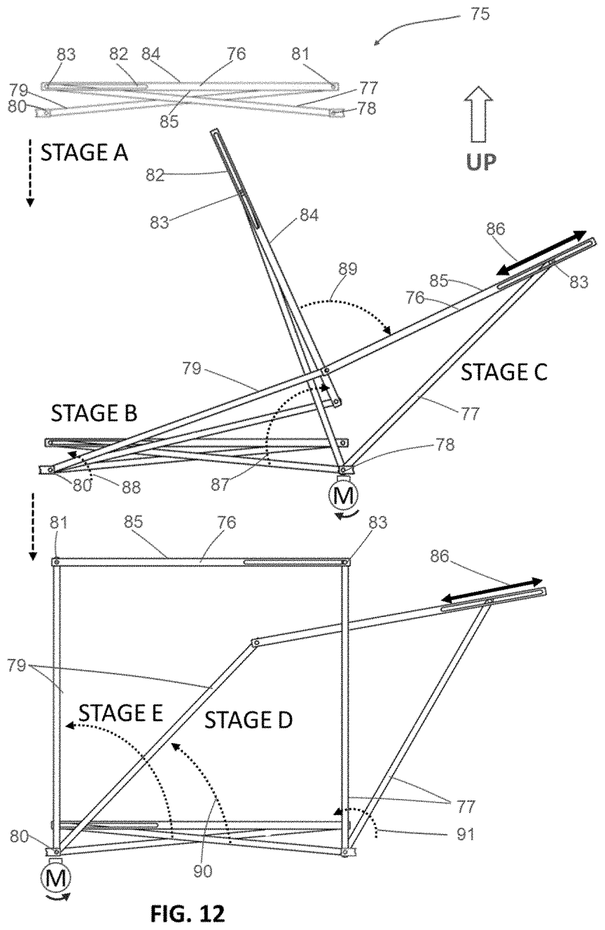

In yet another aspect of the invention, FIG. 12 demonstrates another mechanism for the invention to retract tabletop surface using linkage, crank and slider, as shown in 75. The invention is in fully stowed arrangement at Stage A with the tabletop member 76 mostly horizontal, tabletop legs 77 and 79 located under the floor level 7 in FIG. 1, and tabletop surface 84 facing up. The proposed mechanism consists of two independent rotary or linear actuators that act on tabletop legs 77 and 79 at pivotable joints 78 and 80, respectively to rotate tabletop legs 77 and 79 along trajectories 87 and 88, respectively. Tabletop leg 79 is pivotably attached to tabletop linkage frame member 76. Tabletop leg 77 is slidingly joined with the tabletop linkage frame member 76 through peg 83 and sliding slot 82, thus creating a crank and slider arrangement. In fully stowed arrangement, clean, dining surface 85 of the tabletop linkage frame member 76 is facing down while the utilitarian surface 84 is facing up. First step of converting the invention from fully stowed to retracted arrangement starts with first actuator acting at pivotable joint 78 on tabletop leg 77 to rotate it along trajectory 87 to Stage B while the non-actuated tabletop leg 79 follows along trajectory 88. At Stage B the tabletop linkage frame member 76 goes through a vertical position where slot 82 is positioned substantially vertically. After that moment tabletop link 76 turns upside down around trajectory 89 so that the clean, dining surface 85 faces up and the utilitarian surface 84 faces down. The turning is facilitated by peg 83 sliding and freely rotating within slot 82 along path 86 until tabletop link 79 and tabletop link 76 are mostly colinear as shown at Stage C in 75. Second step of the invention retraction continues with the actuator at pivotable joint 80 acting on tabletop leg link 79 to turn it along trajectory 90 to Stage D, which is the position that defines nearly fully retracted arrangement of the invention. Tabletop leg link 77 is not actuated during the second step of the retraction, and follows trajectory 91. The mechanism is fully retracted at Stage E where tabletop leg links 79 and 77 are substantially vertical, tabletop linkage frame member 76 is substantially horizontal, and clean dining surface 85 faces up.

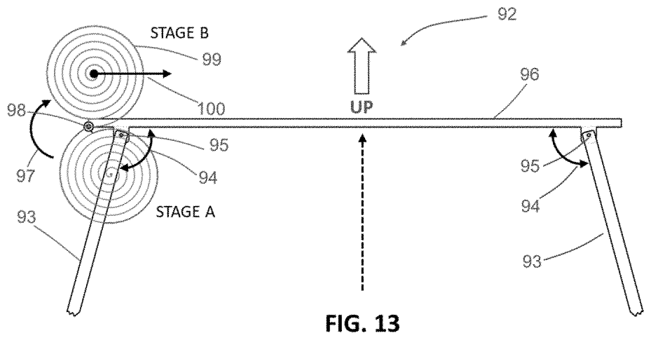

In yet another aspect of the invention, FIG. 13 demonstrates another mechanism for the invention to retract tabletop surface using linkage and unrolling dining surface, as shown in 92. In fully stowed away arrangement, tabletop legs 93 are nearly horizontal and fit directly underneath tabletop link 96, and clean dining surface 99 is stowed underneath tabletop link 96 as shown at Stage A. In stowed away arrangement, tabletop link 96 is mostly coplanar with floor level 7 in FIG. 1. and serves utilitarian purpose while being exposed to external elements and soiling. The clean dining surface is rolled up in a spiral or similar space-efficient shape and pivotably attached to tabletop link 96 at joint 98. Tabletop leg links 93 are pivotably attached to the tabletop link 96 at pivotable joints 95. To fully retract, actuators act on tabletop leg links 93 to rotate them around pivotable joints 95 along trajectory 94, which in turn moves tabletop link 96 vertically up. Next, clean dining surface 99 is rotated around pivotable joint 98 from Stage A to Stage B and unrolled on top of the tabletop link 96 by being pulled along path 100. Once pulled fully along, at this final stage, the mechanism for the invention is fully retracted with the clean tabletop dining surface 99 available for use.

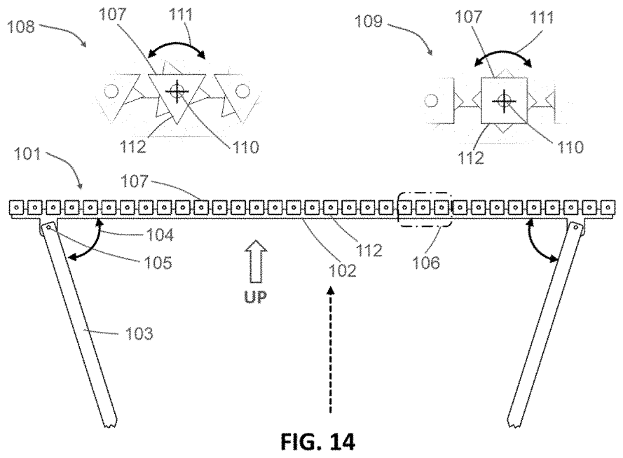

In yet another aspect of the invention, FIG. 14 demonstrates another mechanism for the invention to retract tabletop surface using a series of separate tabletop pivotable covering elements that rotate around their own axes, as shown in 101. In fully stowed away arrangement, tabletop legs 103 are substantially horizontal and underneath tabletop link 102. In fully stowed away arrangement, clean dining surface elements 112 are flipped upside down to protect from weather and elements, while the utility surface elements 107 face upwards being exposed to elements and soiling. Various cross-sections of the tabletop individual surface elements 106 are available, and examples such as triangle shown in 108, or square in 109 are provided. Tabletop leg links 103 are pivotably attached to the tabletop link 102 at joints 105. To fully retract, actuators act on tabletop leg links 102 to rotate them around pivotable joints 105 along trajectory 104, which in turn moves tabletop 102 up. Next, an actuator acts on individual tabletop surface elements shown on 108 and 109 to rotate them by a suitable degree with respect to axis 110 along trajectory 111 until the utility surface 107 face down, and clean, dining surfaces 112 face up. At this stage, the invention mechanism in 101 is fully retracted with the clean tabletop dining surfaces 107 available for use.

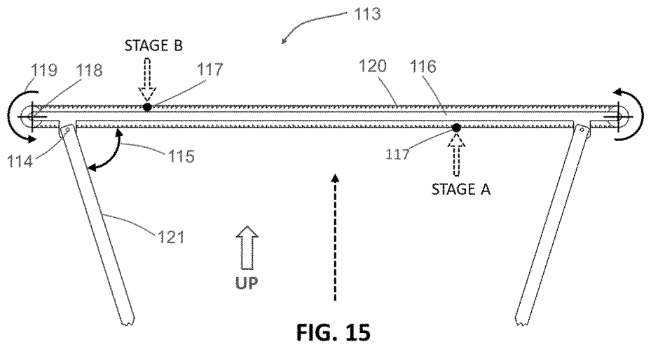

In yet another aspect of the invention, FIG. 15 demonstrates another mechanism for the invention to retract tabletop surface using actuated linkage system and a rolling surface or intermittently rigid or completely flexible tabletop surface resembling that of an athletic treadmill as shown in 113. In fully stowed away arrangement, tabletop legs 121 are nearly horizontal and stored underneath tabletop link 116. The clean part of dining surface 120 is underneath 116 when in stowed away arrangement. For clarity of explanation, imaginary reference marks 117 located on surfaces 120 are displayed at Stage A and Stage B. In stowed away arrangement, reference mark 117 is at Stage A in 113, and the part of dining surface 120 with Stage A mark is clean and hidden away from external elements and weather. In fully retracted arrangement, mark 117 moves to Stage B, thus exposing the clean part of surface 120 for dining, and hiding the utilitarian, dirty section of surface 120 underneath tabletop link 116. Tabletop leg links 121 are pivotably attached to the tabletop link 116 at joints 114. To fully retract, actuators act on tabletop leg links 121 to rotate them around pivotable joints 114 along trajectory 115, which in turn moves tabletop link member 116 vertically up. Next, an actuator acts on tabletop dining surface 120 to spin the continuous dining surface 120 along trajectory 119 with respect to rollers attached on axes 118. Clean section of tabletop dining surface 120 is moved along trajectory 119 until mark 117 moves from Stage A to Stage B. At this stage, the invention utilizing mechanism in 113 is fully retracted with the clean section of tabletop dining surface 120 available for use.

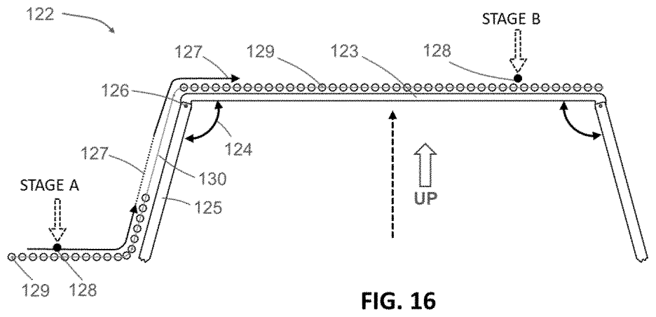

In yet another aspect of the invention, FIG. 16 demonstrates another mechanism for the invention to retract tabletop surface using actuated linkage system and a pullover tabletop surface of rigid or flexible construction, as shown in 122. In fully stowed away arrangement, tabletop legs 125 are nearly horizontal and stored underneath tabletop link 123. The clean dining surface 129 is hidden away and stored under linkage member 123 and floor surface 7 in FIG. 1. In stowed away arrangement, reference mark 128 is situated at Stage A of 122 to protect the clean dining surface 129 from weather and external elements, while the tabletop linkage element 123 faces up and represents the utilitarian side of invention mechanism and is exposed to weather, external elements and soiling. Tabletop leg links 125 are pivotably attached to the tabletop link 123 at joints 126. To fully retract, actuators act on tabletop leg links 125 to rotate them around pivotable joints 126 along trajectory 124, which in turn moves tabletop link member 123 up. Next, an actuator acts on tabletop clean dining surface 129 to move the dining surface 129 along trajectory 127 using cable and guide system 130 or similar suitable approach. Clean tabletop dining surface 129 is moved along trajectory 127 until the dining surface 129 fully covers the upper side of link member 123. For clarity of explanation, and by example only, marker 128 needs to travel a suitable distance along trajectory 127 to move from Stage A to Stage B as defined in 122. The mechanism is fully retracted when marker 128 is at Stage B. At this stage, the invention utilizing mechanism in 122 is fully retracted with the clean tabletop dining surface 129 available for use.

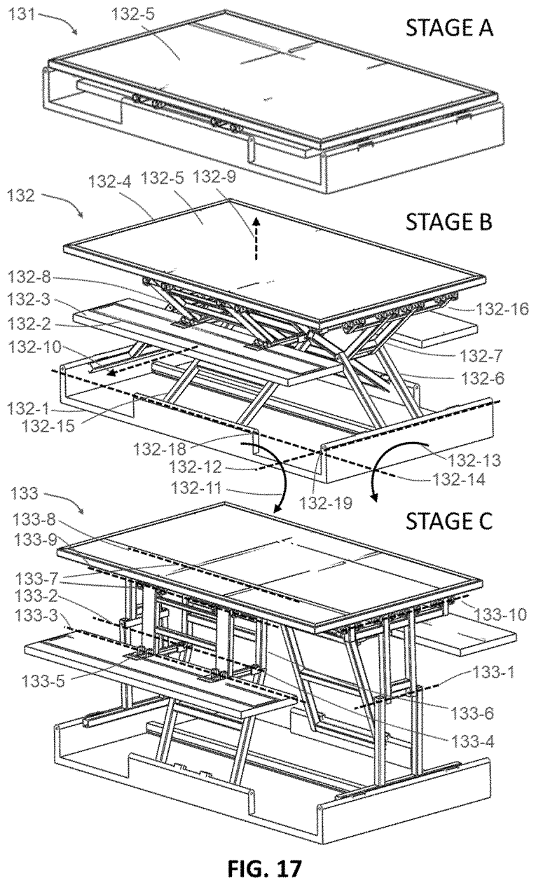

In yet another aspect of the invention, FIG. 17 demonstrates another mechanism to retract and stow away tabletop and seating surfaces using sets of concurrent pivotable linkages, commonly referred to as sarrul linkage, coupled with four-bar linkages and powered by rotatable or linear actuators acting on one or multiple link members within the mechanism as shown in 131, 132, 133. The invention is in fully stowed arrangement at Stage A in 131 with the tabletop surface 132-5 and seating surface 132-3 horizontal and located under the floor level 7 in FIG. 1. The invention is partially retracted at Stage B in 132, with the tabletop surface 132-5 being substantially higher than the floor level 7 in FIG. 1, and structural members 132-6 and 132-7 creating an angle less than 180 degrees between themselves. The invention is fully retracted at Stage C in 133 where members 132-6 and 132-7 are substantially parallel to each other, thereby creating an angle of approximately 180 degrees between themselves, and seating surfaces 132-3 have reached their lateral travel limit along path 132-10 when measured with respect to structural member 132-6 and 132-7. The proposed mechanism consists of general frame 132-1. Tabletop surface 132-5 is rigidly mounted to, or a part of, tabletop frame component 132-4. Tabletop surface frame component has six pivotable connections 133-7 and 132-16. Pivotable connections 133-7 are located along the long, opposite edges of tabletop frame 132-4, and pivotably connect the tabletop frame 132-4 to upper seating surface support frame members 133-6 and 132-8, thus creating axes of rotation 133-8 and 133-9, respectively. Pivotable connections 132-16 are located along the shorter, opposing edges of tabletop frame 132-4, and pivotably connect the tabletop frame 132-4 to upper tabletop supporting frame members 132-7, thus creating axes of rotation 133-10. Seating surfaces 132-3 are rigidly mounted, or a part of seating surface frame component 132-2. Seating surface frame 132-2 integrates two pivotable joints 133-4 and 133-5 to create a parallel four-bar linkage with 133-6 and 132-8, and tabletop frame member 132-4. In other words, seating surface frame member 132-2, seating support member 133-6, 132-8 and tabletop surface frame member 132-4 create a parallel four-bar mechanism with pivotable axes 133-2, 133-3, 133-8, 133-9 that result in seating surface 132-3 moving along the path defined by 132-10. Thereby, such parallel four-bar linkage guarantees that the tabletop surface 132-5, seating surfaces 132-3 and floor level 7 in FIG. 1 are always parallel to each other, during stowed away Stage A, transitional Stage B and fully retracted Stage C of FIG. 17. General frame member 132-1 has four pivotable connections 132-19 and 132-18. Pivotable connections 132-18 are located along the long, opposite edges of the general frame member 132-1, and pivotably connect the general frame 132-1 to lower seating surface support frame members 132-15 and allow relative pivotable rotations around axes 132-14. Pivotable connections 132-19 are located along the shorter, opposing edges of general frame 132-1, and pivotably connect the general frame 132-1 to the lower tabletop surface support frame members 132-6, and allow relative pivotable rotations around axes 132-12. Lower tabletop supporting frame members 132-6 are pivotably connected to upper tabletop supporting frame members 132-7. Similarly, lower seating surface supporting members 132-15 are pivotably connected to upper seating surface support frame member 133-6. Axes 132-12, 132-14, 133-2, 133-1, 133-8 and 133-10 create so called sarrul linkage, which is advantageous because the tabletop surface 132-5 follows precisely the vertical path 132-9 when transitioning from Stage A to Stage B and to Stage C, and cancels out undesired lateral degrees of freedom. Such transformation is achieved using several diverse methods, such as linear actuators, motors, gears, hydraulic or pneumatic actuators acting on a single or a combination of multiple frame components 132-1, 132-2, 132-4, 132-15, 133-6, 132-8, 132-6, 132-7. The exact method of actuating is dependent on space and application requirements, and transitioning from Stage A to Stage C will result in member 132-15 pivoting around axis 132-14 as defined by path 132-11, member 132-6 pivoting around axis 132-12 as defined by path 132-11, tabletop surface 132-5 moving up along path 132-9, and seating surfaces 132-3 moving laterally as defined by path 132-10.

In yet another aspect of the invention, FIG. 18 provides, by an example only, a simplified network and control diagram 134 for the invention. Invention hardware in FIG. 18 comprises one of the aforementioned invention mechanisms equipped with the necessary sensors and actuators. Sensors may include a combination of potentiometers, laser, vision and optical sensors, strain gauges, and encoders to provide positional feedback control for retracting and stowing algorithms of the invention. Safety sensors may include current sensors to detect motor overloading, or area safety laser sensors, light curtains, strain gauges or presence sensors. Actuators may comprise linear or rotary actuators powered by hydraulics, pneumatics, magnetic fields or electric motors. The invention is equipped with emergency overwrite that shuts down the entire system and de-energizes the invention, thus bringing it to a safe state. The invention is electronically controlled by an IoT compatible control board. The board has Input/Output capability to receive sensory data from the invention, and to control actuators on the invention. The invention is intended to retract and stow away by itself in fully automatic mode during general use, however manual control is possible for calibration and safety reasons. Manual control allows the user to stow and retract the invention by pressing controls locally at the control board, including individual actuator control. In its most preferred mode of operation, the invention is controlled by IoT infrastructure that communicates with the invention through a firewall-protected gateway, such as Wi-Fi router. Web application and mobile applications in diagram 134 are available for the invention to be controlled over network. Commands from the user are patched in user/business logic unit in diagram 134, and then are sent to control applications, where control routines are set up, control data is generated, and the commands are forwarded to the invention through cloud gateway. Security of information and data is always monitored while the invention is online. Device administration is available to authorized users, and are configured through user administration options. Depending on final application of the invention, such as, for example, on airplanes, parks, vessels where communication with the invention and schedules are of essence higher degree of autonomy is required. Therefore, the invention may have additional sensors to sense weather such as rain or wind, and react accordingly, or may have an application programming interface (API) that communicates with a weather forecasting internet website to predict weather on frequent basis. Examples include stowing away when heavy wind and rain are present, and the invention is not used. Another example of additional intelligent features include communication with the user's calendar or schedule, and retract or stow accordingly. For example, the user may have an event at night, and the invention automatically retracts beforehand. Alternatively, the local parks or cruise ships may decide that the tabletop and seating surfaces must be retracted at a certain hour to avoid unexpected people gathering and to facilitate cleaning of areas. Therefore, to achieve these, and additional features, the invention is equipped with data warehouse that collects data from sensors and user logic to analyze the data and facilitate machine learning to generate models creations. The models will dictate control applications and actions that must be taken depending on the schedule and calendar events of the user, weather conditions and weather forecasts. Control applications generate appropriate control data and send it back to the invention through cloud gateway, which in turn is processed by gateway. IoT capable controller unpacks the data and controls the invention accordingly.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the invention may be utilized in various combinations and/or independently. Thus, the invention is not limited to only those combinations shown herein, but rather may include other combinations.

What is claimed is:

1. An automatically converting, floor raising tabletop and seating furniture element that has at least one set of clean seating and tabletop surfaces at all times comprising:
a tabletop surface;
a plurality of seating surfaces;
an assembly of covers;
an extension assembly;
a general frame coupling components together;
wherein relative movement and position of said components is controlled by an IoT capable control board; wherein the tabletop, seating surfaces, extension assembly and covers are automatically adjustable between a stowed away position and an extended position, thereby the said components are disposed beneath or adjacent to the nearest surface defining floor when said components are in stowed away position, and the tabletop surface, seating surface and extension assembly are disposed a greater distance above the floor defining surface when said components are in fully extended position than when the said components are in stowed away position.

2. A furniture element of claim 1, wherein said tabletop surface, seating surface and covers are attached to respectable attachment components on said extension assembly;

3. A furniture element of claim 1, wherein said general frame is rigidly embedded beneath or adjacent to the nearest surface defining floor with suitable anchoring points across the perimeter;

4. A furniture element of claim 1, wherein said extension assembly comprises actuators, pivotable and slidable joints, single and multiforce members, linkages and sensory equipment for control of relative position and movement of said tabletop surface, seating surfaces, covers and individual extension assembly members with respect to each other and said general frame;

5. A furniture element of claim 1, wherein said seating surface comprises pivotable elements for pivotable attachment to the said seating extension assembly, and stopping elements for fully extended and retracted positional control;

6. An extension assembly of claim 1, wherein pivotable seating surface link of the said extension assembly rotates between extended and stowed away limit points with the help of gravity applying gravitational force downwards, and is lifted up and down radially with a help of actuator acting on the near extension assembly member;

7. A furniture element of claim 1, wherein said assembly of covers comprise concurrent pivotable cover elements arranged at 90 and 180 degrees with respect to each other, and acted upon by force members at actuation points located equidistantly from the pivot axis;

8. An extension assembly of claim 4, wherein tabletop surface link, upper leg components, and lower leg components of the said extension assembly are pivotably joined to each other, positionally controlled by actuators, and travel limited by stopping elements;

9. An extension assembly of claim 4, wherein tabletop surface retraction mechanism is described as five bar mechanism acted upon by two independent actuators acting on said lower tabletop leg components; wherein excessive degrees of freedom are restricted by stopping elements;

10. An extension assembly of claim 4, wherein tabletop surface retraction mechanism is described as scissor mechanism combined with crank and slider mechanism embedded between the two-piece tabletop link and one leg of scissor mechanism; wherein the slider acts on the second tabletop link to pivot it around its short edge and to open it, thereby revealing the clean tabletop surface;

11. An extension assembly of claim 4, wherein tabletop surface retraction mechanism is described as linkage mechanism to lift the tabletop, and the said tabletop is rotated by actuator around its central longitudinal axis by 180 degrees to turn the tabletop surface upside down to reveal the clean dining surface;

12. An extension assembly of claim 4, wherein tabletop surface retraction mechanism is described as longitudinally foldable linkage mechanism consisting of three parallel vertical leg links and four foldable tabletop horizontal links all pivotably connected together and rotatable around central vertical leg link; whereas transformation involves turning the central link to upright orientation and longitudinal retraction of outermost vertical members to unfold the four clean tabletop horizontal links;

13. An extension assembly of claim 4, wherein tabletop surface retraction mechanism is described as dual input four bar linkage combined with a peg and groove mechanism between the top link and one leg of scissor mechanism; wherein the tabletop link is turned upside down by predefined actions of two actuators on leg members and the peg and groove mechanism;

14. An extension assembly of claim 4, wherein tabletop surface retraction mechanism is described as linkage mechanism wherein tabletop legs are pivotable with respect to tabletop link and clean tabletop surface is rolled up underneath the tabletop link when stowed away and unrolls atop of tabletop link to reveal clean dining surface;

15. An extension assembly of claim 15, wherein clean tabletop surface comprises a plurality of synchronously actuated individual tabletop surface elements of polygonal cross-section that are pivotable with respect to their own central axes to reveal clean dining surfaces;

16. An extension assembly of claim 15, wherein clean tabletop surface comprises a substantially flexible continuous surface between two rollers resembling running exercising treadmill; wherein one of the rollers is actuated and moves the clean dining surface along until the clean dining surface from beneath appears on top;

17. An extension assembly of claim 15, wherein clean tabletop surface comprises a chain of individual tabletop surface elements linked together and stowed away; wherein the individual tabletop elements are pulled like a chain on top and across the soiled tabletop structural element by actuators to reveal the clean dining surface;

18. A furniture element of claim 1, wherein said tabletop surface, seating surface and extension assembly represent a concurrent sarrus linkage actuated by at least one actuator; wherein seating surface is automatically retracted substantially parallelly with respect to tabletop surface by implementing a parallel four bar linkage;

19. The convertible furniture element of claim 1 wherein retraction and stowing is on demand or automatically handled and controlled with a multitude of sensors and actuators, powered by an Internet of Things compatible controller with machine learning; wherein manual overwrite of the IoT controller is available for debugging, installation, calibration purposes and emergency or power outage events.
